(19) United States
(12) Patent Application Publication
(10) Pub. No.: US 2011/0201319 A1
(43) Pub. Date: Aug. 18, 2011

(54) INTERACTIVE SYSTEM FOR GUIDANCE AND INFORMATION ON MOBILE TELEPHONE OR ANALOGOUS TERMINAL

(75) Inventors: Atmin Ait Hamouda, Lyon (FR); Frederic Chazelle, Tassin (FR)

(73) Assignee: EMBEDIA, Villeurbanne (FR)

(21) Appl. No.: 13/057,537

(22) PCT Filed: Jul. 9, 2009
(86) PCT No.: PCT/FR2009/051365

§ 371 Date: May 2, 2011

(30) Foreign Application Priority Data
Aug. 6, 2008 (FR) 08/04497

(51) Int. Cl. H04W 4/00

(52) U.S. Cl. 455/414.1

(57) ABSTRACT

The system is aimed in particular at guiding and informing persons with reduced mobility. It comprises a fixed apparatus (1) with a central processing unit, which communicates by radio waves with mobile telephones (2) or analogous terminals, loaded with a specific programme, which are carried by the users. The latter can thus receive in real time, in a zone (5) centred on the fixed apparatus (1), information in connection with the place at which this apparatus is installed. This system applies in particular to an urban transport network, for guiding and informing travellers at waiting or stopping points.

### TECHNICAL FIELD

The present invention relates, in general, to an interactive system for guidance and information, operating on a mobile telephone or an analogous terminal, such as a personal digital assistant, carried by a user of the system. This invention more particularly, but not exclusively, relates to a system for guidance and information usable by people with reduced mobility, in particular with the aim of facilitating the orientation and travel of such people in public transportation systems or in public buildings, or in other similar locations or areas, other types of people also being able to be concerned.

### BACKGROUND

The generalization of the mobile telephone, the new wireless connection technologies and the new behaviors created by the Internet are in particular causing lasting changes in the relationship people have with their immediate environment and instant access to information. The public would like to be able to have contextual information delivered during daily travel, and to use that information either immediately, or later. However, they do not have the time or means to note this information and thus forget it quickly. They also cannot interact with the information, in particular view it selectively, make reservations, or participate in another way.

These general difficulties are even more pronounced for people faced with the additional difficulty of traveling and who are subject, in their travel and/or other actions, to hindrances that they cannot, or can only with great difficulty, overcome alone, therefore without outside help, these people generally being referred to as “people with reduced mobility.”

This category in particular includes people who, due to an accident, illness, or congenital ailment, experience difficulties in moving, seeing, hearing or understanding, as well as people suffering from a temporary impairment, for example a broken leg. This category should also be extended to include people who are well but are accompanied by a young child and/or who have luggage, bags, etc., or people experiencing temporary comprehension difficulties, such as foreigners or tourists who do not understand the local language.

People with reduced mobility represent an enormous group of the population, and thus thirty-five percent of the French population meets this classification, among whom approximately:
3 million are people suffering from a visual impairment,
5 million are people suffering from a hearing impairment,
8 million are people suffering from a motor impairment.

It should also be noted that, France being one of the leading tourist destinations in the world, there are many tourists faced with comprehension difficulties there.

In order to facilitate the integration of these people in particular in terms of access to information, public buildings and public transportation, legislative measures have already been taken, in particular in France in 2005, but also in other western countries, providing that “ . . . the chain of movement, which includes the built environment, roads, the development of public spaces, the public transportation system, and their intermodalism, is organized to make it accessible to all people with handicaps or reduced mobility. Within ten years of the publication of this law ( . . . ) the public transportation system must be accessible to people with handicaps or reduced mobility.”

(excerpt from Article 45 of French law no. 2005-102 on equal rights and opportunities, participation and citizenship of handicapped people)

Similar resolutions have also been adopted on the European level.

To facilitate access to buildings and transportation systems for people with reduced mobility, among other things, these people should be provided with adapted information, able to guide them taking their handicap into account. Various methods exist, or are at least being contemplated, at this time.

Known mobile telephone and mobile Internet access solutions exist, but they most often require heavy infrastructure (GSM networks, satellites) and users must pay for them, without, however, allowing users to interact simply and effectively with their immediate environment, while they must continuously update their communications to accompany them in their day-to-day life. Moreover, these solutions do not work, or only work poorly, in some indoor settings, such as underground passages and subway stations or tunnels, due to the lack of networks in such spaces. Furthermore, even if they work correctly, these communication solutions towards mobile telephones usually only deliver general or commercial information, addressed to the entire population (e.g. weather updates, advertisements, games), without addressing a specific type of audience and, most often, without any relationship to the user's location. Lastly, the wireless or telephone solutions considered here generally require many manipulations by the user (such as calling a particular number, receiving a text message, choosing a mobile Internet link, selecting content, validating), which remain complex for any person, including and handicapped people especially and in particular people with visual impairments.

Position determination systems of the GPS type exist, but are often very little used in common devices of the mobile telephone type and most often use small computers carried in shoulder straps with an antenna, a GPS receiver and a speaker. In addition to the need for the user to carry this heavy equipment, these systems also suffer from problems relative to reception and quality or precision of the GPS signal due to the built environment (highly urbanized areas, covered or indoor locations), the difficulty of miniaturizing individual packages, and the imprecision of geographical readings.

Other systems exist, which aim to inform and direct. Known for example are remote controls for people with visual impairments or the blind, allowing them to obtain, from three-color traffic lights with sound, information on the current status of the crosswalk for a street. Audio beacons activated by these same remote controls, or activated by pushing a button as is the case for certain bus stops, for example, also make it possible to receive sound messages on request. The information is broadcast here by low-frequency radio systems, which transmit in all directions within a radius of about one hundred meters. These systems are designed to provide invariable information, such as direction indications, but they quickly show their limitations when it involves broadcasting dynamic information. In all cases, users must be equipped with specific apparatuses that actuate the operation of a loudspeaker, which can be considered a source of noise pollution. Not being directional, these systems have the drawback of being interfered with by parasitic electromagnetic waves with a close frequency. Moreover, these systems are considered indiscrete, because the sound messages are delivered to everyone in the vicinity, which does not make it possible to meet the assistance needs of a person with reduced mobility discretely and anonymously. Lastly, this is a dedicated solution for people with a specific handicap, and is not intended for all people with reduced mobility.

The magnetic loop is a known system for electromagnetic transmission of a sound wave. It is an effective solution, even in the presence of parasitic noises, only for hearing-impaired people wearing a hearing aid equipped with a “T” function (telephone position). The operating principle here is close to that of an amplifier combined with a microphone and a speaker. As in the preceding case, this solution is still very specific to a particular type of handicap.

Similarly, other devices exist that are very specific to a handicap, for example a visual one, such as the radar cap, the radar pendant, or the laser cane, used to detect obstacles and requiring that the user have a particular apparatus, without offering a universal solution in terms of adaptation to various handicaps. Moreover, the use of such means requires some learning and correct posture by the user. Lastly, in their basic versions, these detection means are more for safety rather than being a solution allowing users to situate and orient themselves, in particular in an unfamiliar setting.

Lastly, traditional information systems should be cited such as display panels or screens, LED displays or speakers, which are sometimes not accessible depending on the person's position (distance, obstacles, crowd) and which most often remain unusable for people with reduced mobility, such as those with visual or hearing impairments and those with physical handicaps.

### BRIEF SUMMARY

Faced with the multiple drawbacks of the current solutions, recalled above, the present invention aims to provide an interactive system for guidance and information, usable with a mobile telephone and more generally with any type of similar portable terminal, therefore not requiring specific and heavy equipment, and able to work for any type of handicap without excluding use by any person, the proposed system providing real and “local” assistance to users in relation to their location including enclosed locations such as buildings or underground, without excluding public transportation, the system being easy to use and allowing a real “dialogue.” One more particular aim of the invention is to provide a system intended for so-called people with reduced mobility so as to facilitate the orientation and movements of those people, as well as their access to information, in public transportation systems, public buildings, and any other similar locations or areas.

To that end, the invention relates to an interactive system for guidance and information, working on a mobile telephone or an analogous terminal, more particularly intended for people with reduced mobility, the system comprising, on one hand, a fixed apparatus with a central processing unit, a memory containing digital messages to be transmitted and received data, a radio wave communication interface connected to a radio antenna, and an external and/or internal power source, the fixed apparatus being loaded with a specific program designed to manage communication with mobile telephones or analogous terminals using a specific universal connection identifier, and on the other hand, equipping a user's mobile telephone or analogous terminal, provided with a radio wave communication interface, with a specific application managing the communication with the fixed apparatus, thereby making the mobile telephone or analogous terminal capable of exchanging with said fixed apparatus, in particular to receive information related to the location where said fixed apparatus is found.

It will be noted that in this definition, the expression “fixed apparatus” is used as opposed to the portable apparatus the user has, but does not mean that said fixed apparatus is completely immobile; thus, the “fixed” apparatus can be placed onboard a public transportation vehicle.

Thus, the principle of the solution proposed by the invention lies in the establishment of a “dialogue” between an apparatus installed in a specific location, such as a bus stop or a subway platform in the case of a public transportation network, or the reception area in the case of a public building, on one hand, and a portable device such as a mobile telephone or personal digital assistant previously loaded with a specific application, on the other hand. Owing to this dialogue, any person, and in particular a person with reduced mobility, can be covered and informed, either visually (in the case of a hearing impairment or a foreigner), or vocally (in the case of a hearing impairment or also a foreigner), automatically once the specific application is activated by the user. In particular, after activation of the application on the portable telephone or terminal, the latter automatically looks, in its immediate environment, for example a radius of 20 to 30 meters, for the specific universal identifier making it possible to recognize and locate the fixed apparatus and/or the secure access points that authorize the usage thereof. The fixed apparatus then establishes a permanent communication channel via an identification protocol and two-way authorization, to establish a dialog by radio wave communication with the concerned telephone or terminal, in order to deliver real-time information to the user in visual or sound form related to the equipped location. The communication is cut either deliberately by deactivating the specific application on the telephone or terminal, or automatically when the user, therefore the telephone or terminal, leaves the interaction area with the fixed apparatus.

Advantageously, this fixed apparatus is also connected to a remote station for capturing and updating information to be delivered, so that the information delivered to the telephones or terminals can be updated.

The specific application, integrated into a telephone or terminal, receives the information broadcast by the fixed apparatus, and presents it directly, in its original format, to the user. Thus, in the case of a sound sequence, the telephone reads the sequence and makes it audible via its speaker; if it involves a video sequence, the telephone directly launches the reading of the sequence and displays it on the screen. The specific application can also receive, from the fixed apparatus, questions the user can answer via the keys on the telephone or other terminal, thereby allowing the latter also to operate as a transmitter, which makes the system truly interactive.

The fixed apparatus advantageously assumes the form of a sealed housing, which is easily integrated into existing communication supports such as electronic display panels, digital information strips, information terminals for travelers, bus stop signposts, or even windows or displays. Inasmuch as the housing of the fixed apparatus, or the support receiving said apparatus, can hinder the transmission of radio waves, the radio antenna of said apparatus is advantageously an antenna outside the housing. The fixed apparatus can also be easily connected to any telecommunications network, in particular a computer network, to allow it to be controlled remotely by the information capture and update station.

The interactive guiding and information system, subject matter of the invention, is applicable, inter alia, to a public transportation network, in particular an urban transportation network such as a bus network, for guiding and informing travelers about holding points or stops on the network. In this application, the fixed apparatus can easily be housed in a communication support, existing or to be created, such as a signpost or panel, usually placed at a holding point or stop of the concerned public transportation network.

Still in the context of the application of the invention to a public transportation network, the guiding and information system can also comprise a radio connection of the fixed apparatus with a public transportation vehicle such as a bus, located on the approach of the holding point or stop equipped with the system; this radio connection is provided to alert the bus driver in the event a person with reduced mobility has indicated their presence using the telephone or other terminal, at the considered holding point or stop. The driver can thus prepare to receive the person with reduced mobility.

Overall, the guidance and information system has the following advantages:
it is intended for all types of handicaps and situations, and in particular people with reduced mobility, to meet their orientation and information needs.
the only apparatus the user must have is a mobile telephone or a mobile terminal such as a personal digital assistant, which are currently very generalized apparatuses, no specific apparatus being necessary.
The system can operate in all locations, including in enclosed locations such as buildings as well as underground areas.
The connection manipulations are simplified for users: one simple press of a key on the mobile telephone is all it takes to activate the system.
Furthermore, users can activate or not activate the system at any time, depending on their guidance and information needs.
The information received is directly and instantly accessible, i.e. viewable and/or audible, on the telephone, without complex manipulations, regardless of the form of that information: sounds, text, fixed images, video sequence.
The system allows geo-localized interaction, by providing “local” information and assistance, taking the local context into account.
The transmission and reception time for the information is immediate, because the system locally “loads” the information into its fixed apparatus, and does not require, in its basic operation, access to a remote data server.
The fixed apparatus can manage several telephones, therefore several users, simultaneously, possibly with specific management; thus, in the event two users were to connect at the same time, the fixed apparatus can compare the distances according to the strength of the signals, and give priority to the person thus detected as being closer.
The interaction radius of the system can be made adaptable.
The use of the system is free, in particular it does not involve any per-use telephone connection fees.

### BRIEF DESCRIPTION OF THE DRAWINGS

The invention will be better understood using the following description, in reference to the appended diagrammatic drawing showing, as an example, one embodiment of this interactive system for guidance and information on a mobile telephone or analogous system:

FIG. 1 is an schematic diagram, very simplified, of the guidance and information system according to the present invention;

FIG. 2 is a block diagram of the system according to the invention, applied to an urban transportation network;

FIG. 3 shows, in more detail, the fixed apparatus of the system of FIG. 2, associated with a host apparatus;

FIG. 4 is a flowchart of the portable apparatus of this system.

### DETAILED DESCRIPTION

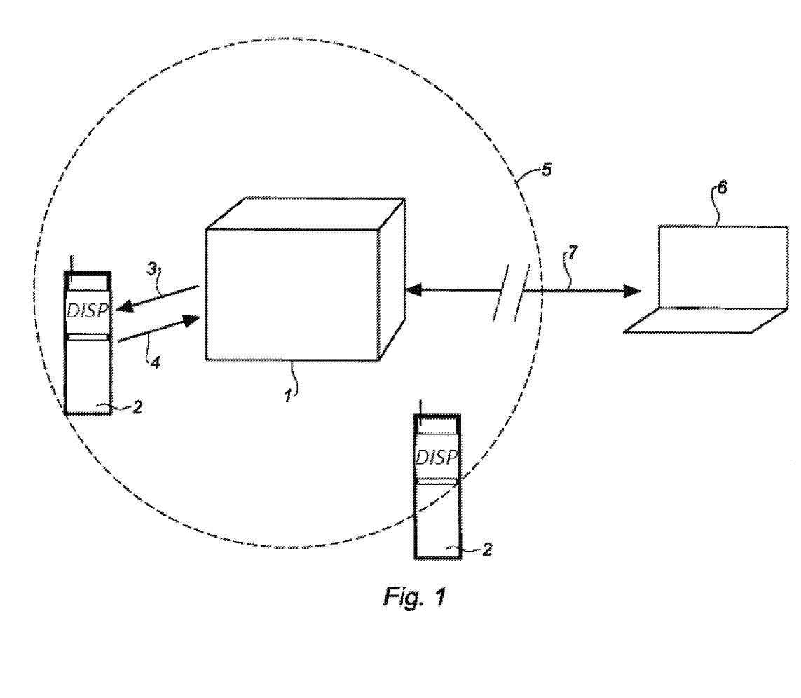

FIG. 1 illustrates the general architecture of a guidance and information system according to the invention. The system comprises a fixed apparatus 1, which is provided to dialog with mobile telephones 2 or analogous terminals, provided with a specific function, via two-way radio connections 3, 4, in a circular or spherical zone 5 centered on said fixed apparatus 1. The fixed apparatus 1 is supervised remotely by a station 6, via a wired or wireless (radio) connection 7. Thus, the connected mobile telephones 2 can receive, from the fixed apparatus 1, information, in particular to guide people, which is delivered in real time, the delivered information being related to the equipped location. The information transmitted by the fixed apparatus 1 to the connected telephones 2 is updated by the remote station 6, which itself is controlled by an operator. The communication is interrupted by deactivating the specific function of a telephone 2, or when it leaves the zone 5 allowing interaction with the fixed apparatus 1.

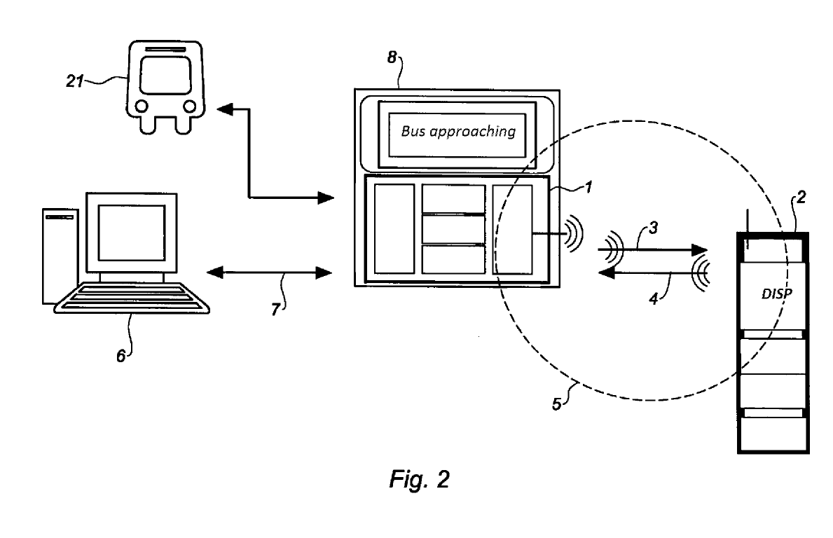

In reference to FIG. 2 and following, this system will now be described in more detail, taking, as a non-limiting example of an application, a system applied to an urban transport network, more particularly a bus network.

The fixed apparatus 1 is placed onboard a “host apparatus” 8, which in general can be an urban fixture, a traditional or electronic display sign, a display screen or an information terminal, etc., and which, in the example application considered here, is in particular a bus stop signpost or panel, of the “variable message panel” type, providing visual information such as the wait time until the next bus arrives, or an indication such as “bus approaching,” in a manner currently well known in itself. The fixed apparatus 1 includes a sealed housing 9, housed inside the host apparatus 8 which, in addition to constituting, for the fixed apparatus, 1 mechanical support, is electrically similar to a Faraday cage. For that reason, the fixed apparatus 1 comprises an antenna 10 placed outside the housing 9 and the host apparatus 8. Lastly, the fixed apparatus 1 comprises a power source from an electrical power distribution system or from the host apparatus 8, and/or electrical power from a battery granting it a certain degree of independence.

On its façade, the host apparatus 8 can have an icon 11 recalling that this host apparatus 8 is part of the guidance and information system.

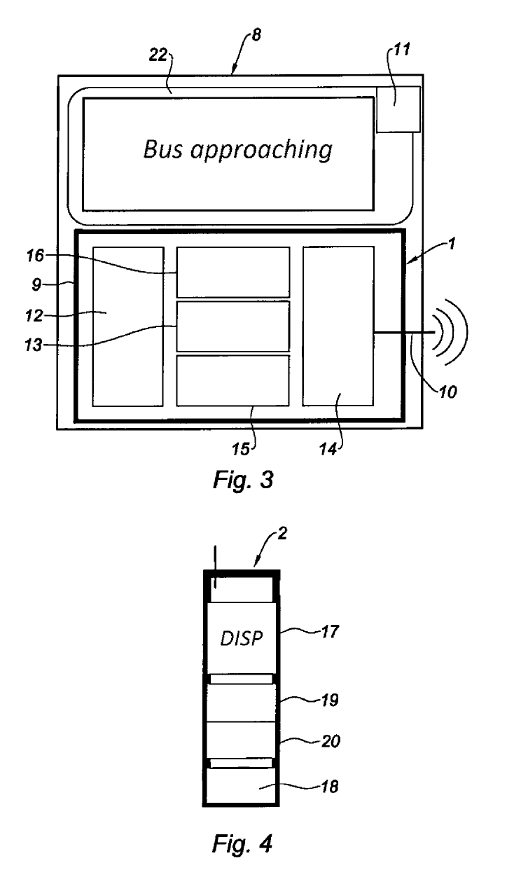

The fixed apparatus 1 strictly speaking assumes the form of an interactive central unit, primarily including: a connection component 12 for the connection 7 with the remote station 6, a central processing unit 13, another connection component 14 connected to the external antenna 10 for communication with mobile telephones 2, a data memory 15 that stores the messages to be distributed and that can also record statistical data, and a program 16 that performs the processing and communication, in particular the automatic formatting of messages and their diffusion towards the mobile telephones 2, as well as the reception of messages coming from the mobile telephones 2—see in particular FIG. 3.

As illustrated in FIG. 4, the mobile telephone 2 adapted for this use comprises, usually, a viewing screen 17, a microphone-earphone assembly 18, and a keypad (not shown). Moreover, this mobile telephone 2 is provided with a program 19 associated with a memory 20, to make the connection with the fixed apparatus 1 and to manage real-time data exchanges with said fixed apparatus 1.

In reference again to FIG. 2, and according to one interesting option, the guidance and information system can also comprise a radio connection with a bus 21 approaching the bus stop considered here, to inform the bus driver that a person with reduced mobility, having used his mobile telephone 2, is waiting at that bus stop, and requires assistance or special attention, depending on the nature of the handicap. The additional radio connection with the bus 21 establishes a mid-range communication, in the vicinity of several hundred meters, which allows the driver to be alerted far enough in advance to prepare for the action to be performed depending on the indicated handicap (e.g. deploying an access ramp, for a person in a wheelchair).

Overall, the operation of the guidance and information system is as follows, considering a user equipped with a mobile telephone 2 loaded with the program 19 specific to that system:

The user starts by activating the connection, and after the connection is activated, the mobile telephone 2 automatically looks, in its immediate environment, for the specific universal identifier that makes it possible to authenticate and locate the fixed apparatus 1 (installed in the host apparatus 8).

The fixed apparatus 1 then establishes a continuous transmission channel, via the radio wave communications protocol of the concerned mobile telephone 2, in order to deliver the information related to the equipped site in real-time. The fixed apparatus 1 thus transmits, to the or each connected mobile telephone 2, the updated information from the remote station 6.

The application incorporated into the considered user's mobile telephone 2 receives the information transmitted to it, and presents that information directly in its original format. Thus, if it is an audio sequence, the telephone 2 reads and audibly restores that sequence on its earpiece 18; if it is a video sequence, the telephone 2 directly launches viewing thereof on its screen 17. The application can also receive questions, which the user can answer using the keys on the keypad of the telephone 2, which then operates as a transmitter, taking advantage of the two-way radio connection 3, 4. Information is also exchanged between the fixed apparatus 1 and the considered user's mobile telephone 2, with various possibilities and options.

Users have the option of selecting their preferences, so as to allow customized access to the information, the type of information transmitted also being able to be selected. This option makes it possible to define a “user profile,” optimizing the interaction between the fixed apparatus 1 and each mobile telephone 2.

The system also provides, advantageously, the option of selecting a language, i.e. the language in which the user wishes to hear audio messages or read messages and video sequences. The system thus makes it possible to translate, into the user's language, the sound or visual information broadcast, but only in the language of the location, from the host apparatus 8.

The audio or video messages received by the user on the mobile telephone 2 can be stored, in the memory 20 of the telephone 2, for later reading or use.

In the context of the considered application, i.e. an urban transport network such as a bus network, the system gives all users the possibility of being informed in real time, on their mobile telephones 2, not only of the information 22 displayed by the host apparatus 8, such as the wait time for the bus, but also other information: traffic, disruptions, construction, exceptional events such as those requiring emergency evacuation, etc. The system is thus used not only in combination and synchronization with the host apparatus 8, which already broadcasts “primary” information, but also as a supplement to the host apparatus 8, to broadcast “supplementary” information, in particular adapted to guide a person with reduced mobility.

The messages exchanged between the fixed apparatus 1 and the mobile telephones 2 can also give rise to real-time exploitation, for example to alert the driver of a bus 21 approaching a stop (see above), or for statistical purposes or other processing of the connections, questions and responses by users.

Of course, the guidance and information system according to the invention is also applicable, with the necessary adaptations, to urban or inter-urban public transportation networks other than bus networks, in particular tramway or subway networks, or railway networks. In these cases, the fixed apparatus can equip all of the usual waiting areas: halls, platforms, shelters for travelers, etc. where users are able to receive information, and in particular to be guided, particularly if it is a person with reduced mobility.

In the context of public transportation networks, the “fixed” apparatus 1 can also be onboard the transportation vehicles themselves, such as buses, tramways, or subway cars, in order to ensure continuous service provided by the guidance and information system. Thus, after the user boards the vehicle the he was waiting for, he can continue to receive useful information on his mobile telephone 2.

Other fields of application can also be considered, for the guidance and information system.

Thus, this system can be applied to guidance and information for people with reduced mobility, and more generally all people needing assistance, in buildings and other enclosed places such as administrative buildings (town hall, post office, etc.), cultural areas such as museums, and other exhibition sites. In the latter case, the system makes it possible to deliver information all throughout a visit, this system allowing visitors to use their own mobile telephones instead of the usual “audio guide” devices.

Similarly, the system can provide guidance and precise information, related to the location, in open spaces: zoos, parks, tourist attractions, etc.

Owing to its interactive nature, and regardless of the application, the system also makes it possible to question the user audience, for opinion or satisfaction surveys, or to perform or facilitate business transactions, by guiding consumers in their purchases according to an initially defined preferences profile.

It would not be beyond the scope of the invention, as defined in the appended claims:
for users, to replace the mobile telephone with any analogous terminal, such as a personal digital assistant, able to be carried by the user and communicate with the fixed apparatus;
concerning the fixed apparatus, to incorporate it into a computer instead of designing it as a specific housing, for example by incorporating it into an on-board computer in a vehicle in the case of an apparatus mounted in a vehicle such as a bus;
to incorporate the fixed apparatus directly into a host apparatus, such as a display panel, when the panel is made;
to adapt the system to all applications, and attaching any additional functions to it depending on the application.

1. An interactive system for guidance and information, working on a mobile telephone or an analogous terminal, such as a personal digital assistant, more particularly intended for people with reduced mobility, the system comprising:
a fixed apparatus with a central processing unit,
a memory containing digital messages to be transmitted and received data,
a radio wave communication interface connected to a radio antenna, and
an external and/or internal power source,
wherein, the fixed apparatus being loaded with a specific program designed to manage communication with mobile telephones or analogous terminals using a specific universal connection identifier, and
wherein equipping a user's mobile telephone or analogous terminal, provided with a radio wave communication interface, a specific application managing the communication with the fixed apparatus, thereby making the mobile telephone or analogous terminal capable of exchanging with said fixed apparatus, to receive information related to the location where said fixed apparatus is found.

2. The interactive system for guidance and information according to claim 1, wherein the fixed apparatus is connected to a remote station for capturing and updating information to be delivered, so that the information delivered to the telephones or terminals can be updated.

3. The interactive system for guidance and information according to claim 1, wherein the information broadcast by the fixed apparatus comprises a sound sequence and/or a video sequence, read by telephone.

4. The interactive system for guidance and information according to claim 1, wherein the fixed apparatus assumes the form of a sealed housing, which can be integrated into a host apparatus comprising an existing communication support.

5. The interactive system for guidance and information according to claim 4, wherein the antenna of the fixed apparatus is an antenna outside the housing.

6. The interactive system for guidance and information according to claim 5, wherein the antenna is placed outside the host apparatus.

7. The interactive system for guidance and information according to claim 2, wherein the fixed apparatus is connected to a telecommunications network comprising a computer-type network, so that it can be controlled remotely by the information capture and update station.

8. The interactive system for guidance and information according to claim 1, wherein it is applied to a public transportation network comprising a bus network, for providing guidance and information to travelers at holding points or stops.

9. The interactive system for guidance and information according to claim 8, wherein the fixed apparatus is housed in a communication support placed at a holding point or stop for the concerned public transportation network.

10. The interactive system for guidance and information according to claim 8, further comprising a ratio connection of the fixed apparatus with a public transportation vehicle such as a bus, located on the approach of the holding point or stop equipped with the system, said radio connection being provided to alert the driver of said vehicle in the event a person with reduced mobility has indicated his presence, using his telephone or other terminal, at the considered holding point or stop.
